(19) United States
(12) Patent Application Publication
(10) Pub. No.: US 2020/0021135 A1
(43) Pub. Date: Jan. 16, 2020

(54) APPARATUS FOR TRANSMITTING WIRELESS POWER, SYSTEM FOR TRANSMITTING WIRELESS POWER WITH THE APPARATUS, AND APPARATUS FOR RECEIVING WIRELESS POWER

(71) Applicant: INDUSTRY-ACADEMIC COOPERATION FOUNDATION, YONSEI UNIVERSITY, Seoul (KR)

(72) Inventors: Yongshik LEE, Seoul (KR); Taejun LIM, Tongyeong-si (KR)

(21) Appl. No.: 16/217,415

(22) Filed: Dec. 12, 2018

(30) Foreign Application Priority Data
Jul. 12, 2018 (KR) 10-2018-0081261

(51) Int. Cl. H02J 50/12; H02J 50/40; H02J 50/90; H01F 27/28; H02J 7/02

(52) U.S. Cl. CPC H02J 50/12; H02J 50/40; H02J 7/025; H01F 27/2804; H02J 50/90

(57) ABSTRACT

Disclosed are a wireless power transmission apparatus, a wireless power reception apparatus, and a wireless power transmission system that include coils formed at both sides as well as coils formed over the above-mentioned coils but formed more eccentrically towards the perimeter. An apparatus for transmitting power wirelessly according to an embodiment of the disclosure may include a first coil layer, which includes a coil, and a second coil layer, which is separated longitudinally from the first coil layer, and which includes coils formed eccentrically at both sides of a coil area of the first coil layer, with the coils of the second coil layer having smaller sizes than the coil of the first coil layer.

### CROSS-REFERENCE TO RELATED APPLICATIONS

This application claims priority under 35 U.S.C. 119(a) to Korean Patent Application No. 10-2018-0081261, filed with the Korean Intellectual Property Office on Jul. 12, 2018, the disclosure of which is incorporated herein by reference in its entirety.

### BACKGROUND

### 1. Technical Field

The present disclosure relates to an apparatus for transmitting or receiving power wirelessly. More particularly, the present disclosure relates to an apparatus for transmitting or receiving power wirelessly with coils. The present disclosure also relates to a power supply system equipped with an apparatus for transmitting power wirelessly.

### 2. Description of the Related Art

Wireless power transmission describes a method of transferring power without contact between the power source and the electronic device and may be classified according to the method of transmission into the inductive coupling type, resonant magnetic coupling type, etc. Wireless power transmission is gaining much attention, as interest in energy ubiquitous technology is growing.

Recent implementations for improving power transfer efficiency include structures having an increased size for the driving coil that transmits power and structures having multiple auxiliary coils inserted into the driving coil to serve as relays.

However, these structures increase the size and volume of the wireless power transmission system and increase the cost of manufacturing the wireless power transmission system. Moreover, such structures can only enhance transfer efficiency associated with the linear distance between the power transmission apparatus and power reception apparatus and are unable to improve transfer efficiency when the power transmission apparatus and power reception apparatus are in a misaligned state, i.e. when there is lateral deviation between the power transmission apparatus and power reception apparatus.

### SUMMARY

The present disclosure was conceived to resolve the problems described above, and an objective of the disclosure is to propose a wireless power transmission apparatus and wireless power reception apparatus that can provide high power transfer efficiency even in a misaligned state.

However, the objectives of the disclosure are not limited to that mentioned above, and other objectives that are not explicitly cited herein would be apparent to a person skilled in the art from the descriptions provided below.

An embodiment of the present disclosure, conceived to achieve the objectives above, provides an apparatus for transmitting power wirelessly to a charging target apparatus for which a supply of power is desired, where the apparatus includes a first coil layer, which includes a coil, and a second coil layer, which is separated longitudinally from the first coil layer, and which includes coils formed eccentrically at both sides of a coil area of the first coil layer, with the coils of the second coil layer having smaller sizes than the coil of the first coil layer.

The wireless power transmission apparatus may further include a third coil layer that is separated longitudinally from the second coil layer and that includes coils formed eccentrically at both sides of the coil area of the first coil layer, where the coils of the third coil layer may have different sizes from the coils of the second coil layer.

The coils formed on the second coil layer and the coils formed on the third coil layer may have symmetrical structures.

The first coil layer, the second coil layer, and the third coil layer may be formed on different substrates.

A feed signal for wireless charging may be provided to at least one coil layer selected by switching from among the first coil layer, the second coil layer, and the third coil layer.

The wireless power transmission apparatus may further include a position detection unit that is configured to detect the position of the charging target apparatus, and the coil layer for providing the feed signal by the switching may be selected based on a position detected by the position detection unit.

Selecting the at least one particular coil layer may be performed by the switching after providing a test feed signal to the first coil layer, the second coil layer, and the third coil layer sequentially, with the at least one particular coil layer selected such that feeding is performed to the coil layer having the highest charging efficiency.

Another aspect of the disclosure provides an apparatus for receiving power wirelessly from a counterpart providing power, where the apparatus includes a first coil layer, which includes a coil, and a second coil layer, which is separated longitudinally from the first coil layer, and which includes coils formed eccentrically at both sides of a coil area of the first coil layer, with the coils of the second coil layer having smaller sizes compared to the coil of the first coil layer.

Yet another aspect of the disclosure provides an apparatus for transmitting power wirelessly that includes a multiple number of substrates stacked sequentially and a multiple number of coil layers formed respectively on the multiple number of substrates, where one of the coil layers is composed of a single coil, the coil layers other than the coil layer composed of a single coil include coils formed eccentrically at both sides of a coil area of the single coil, and the coils of the multiple coil layers have different sizes.

Embodiments of the disclosure make it possible to transmit power even when there is lateral deviation between the target being charged and the apparatus transmitting power (i.e. even when the target being charged and the apparatus transmitting power are not aligned), thereby providing the advantage of increased power transfer efficiency.

Also, embodiments of the disclosure make it possible to improve the degree of freedom as regards misalignment between the target being charged and the apparatus transmitting power.

Additional aspects and advantages of the present disclosure will be set forth in part in the description which follows, and in part will be obvious from the description, or may be learned by practice of the disclosure.

### BRIEF DESCRIPTION OF THE DRAWINGS

FIG. 1 is a perspective view of a wireless power transmission apparatus according to an embodiment of the disclosure.

FIG. 2 is a plan view of a first substrate included in a wireless power transmission apparatus.

FIG. 3 is a plan view of a second substrate included in a wireless power transmission apparatus.

FIG. 4 is a plan view of a third substrate included in a wireless power transmission apparatus.

FIG. 5 and FIG. 6 are graphs representing the transfer efficiency obtained with an embodiment of the disclosure.

FIG. 7 is a conceptual diagram illustrating a wireless power transmission system equipped with a wireless power transmission apparatus.

### DETAILED DESCRIPTION

A detailed description of certain preferred embodiments of the disclosure is provided below with reference to the appended drawings. In assigning reference numerals to the components represented in the drawings, it should be noted that like numerals are applied to like components even when shown in different figures. Also, in describing the present disclosure, certain specific descriptions of well known features or functions may be omitted, if it is deemed that such descriptions may unnecessarily obscure the essence of the disclosure. While the descriptions below focus on preferred embodiments of the disclosure, it is obvious that the technical spirit of the disclosure is not limited to or constrained by such embodiments but rather can be practiced in numerous variations derived by the skilled person.

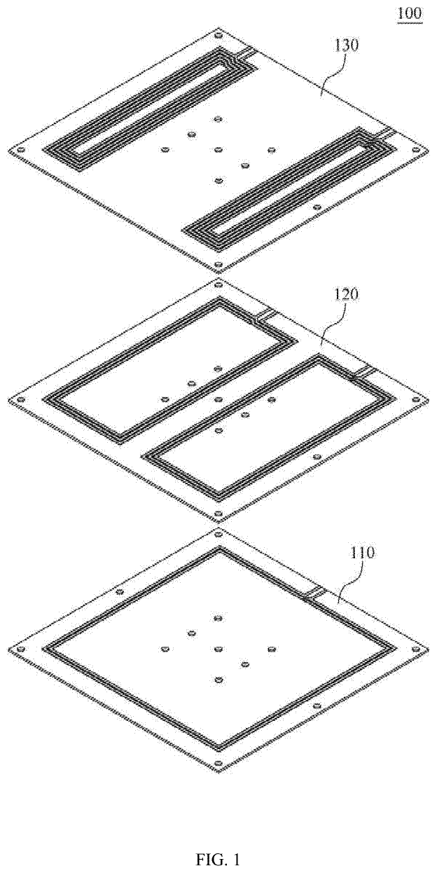

FIG. 1 is a perspective view of a wireless power transmission apparatus according to an embodiment of the disclosure.

As shown in FIG. 1, wireless power transmission apparatus 100 may be for transmitting power wirelessly to a target that is to be charged (e.g. a smart phone) and may include a first substrate 110, a second substrate 120, and a third substrate 130.

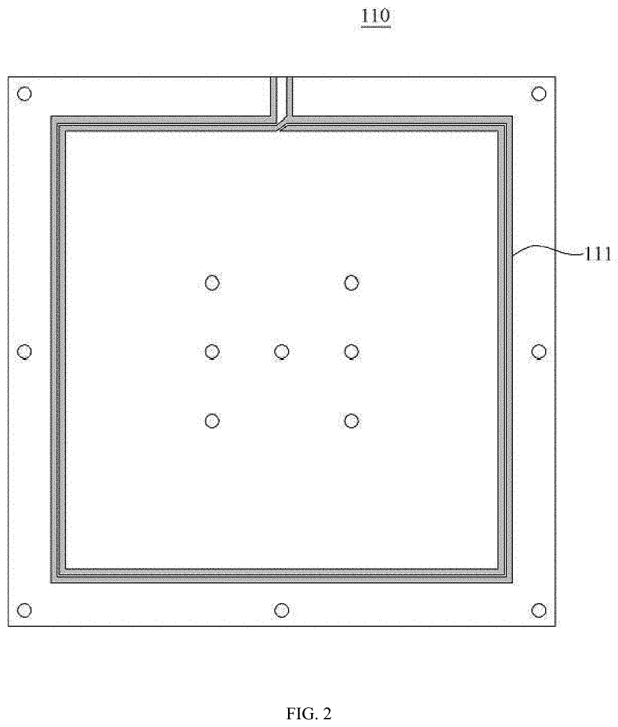

In the following, the descriptions are provided, with reference to the drawings, for each of the first substrate 110, second substrate 120, third substrate 130, etc. First, with reference to FIG. 2, a description is provided of the first substrate 110 and a first coil 111 provided on the first substrate 110. FIG. 2 is a plan view of a first substrate included in a wireless power transmission apparatus.

The first substrate 110 may be positioned at the lowermost layer in the wireless power transmission apparatus 100 and may include a first coil 111 formed on a surface thereof.

The first coil 111 may be a base coil and may be formed along the edges on one surface (e.g. upper surface) of the first substrate 110. Considering that the chargeable area may be determined according to the size of the first coil 111, it may be preferable that the first coil 111 be formed as close as possible to the edge on each side of the first substrate 110.

The first coil 111 can be formed with a predetermined thickness and a predetermined size according to the particular number of turns it is formed in, when the first coil 111 is formed on the first substrate 110. For example, the first coil 111 can have a two turn structure and can be formed in a size of 10 cm˜20 cm*10 cm˜20 cm. Preferably, the first coil 111 can be formed in a size of 10 cm*10 cm.

The first coil 111 can be formed on the first substrate 110 in the shape of a regular square. However, the present disclosure is not to be limited by the shape of the first coil 111. For instance, the first coil 111 can just as well be formed in another shape, including a polygon such as a rectangle, etc., a circle, an ellipse, and others.

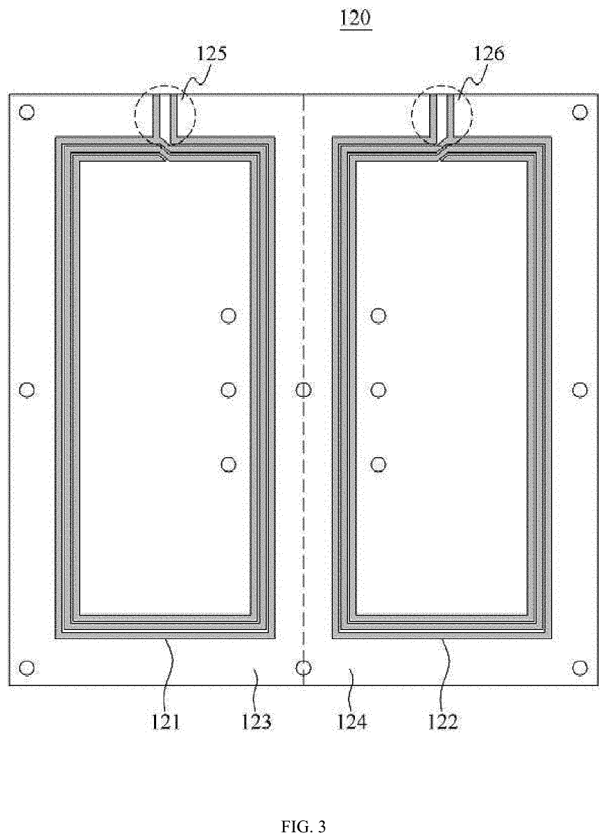

Next, with reference to FIG. 3, a description is provided of the second substrate 120 and a second coil 121 and a third coil 122 provided on the second substrate 120. FIG. 3 is a plan view of the second substrate included in a wireless power transmission apparatus.

The second substrate 120 may be positioned at an intermediate layer in the wireless power transmission apparatus 100 and may be formed over the first substrate 110. The second substrate 120 may include a second coil 121 and a third coil 122, which may be formed on a surface of the second substrate 120 in a symmetrical structure. While the second substrate 120 can be formed with the same size as that of the first substrate 110, it is also possible to form the second substrate 120 in a size different from that of the first substrate 110.

The second coil 121 and the third coil 122 may have smaller sizes compared to the first coil. The second coil 121 and the third coil 122 can be formed to have the same size at both sides on one surface of the second substrate 120. For example, the second coil 121 and the third coil 122 can be formed in the same size at the left side on the upper surface and at the right side on the upper surface of the second substrate 120, respectively. Of course, it is also possible to form the second coil 121 and the third coil 122 at different sides on different surfaces of the second substrate 120. For example, it is possible to have the second coil 121 formed at the left side on the upper surface of the second substrate 120 and have the third coil 122 formed at the right side on the lower surface of the second substrate 120. In this case, the first coil 111 can be formed on the bottom surface of the first substrate 110 so as to prevent contact between the first coil 111 and the third coil 122.

Referring to two equally bisected halves of the second substrate 120 as the 2A substrate 123 and the 2B substrate 124, the second coil 121 and the third coil 122 may be formed along the edges on the same plane of the 2A substrate 123 and the 2B substrate 124. Here, the second coil 121 and the third coil 122 can be formed as close as possible to the edges of the 2A substrate 123 and the 2B substrate 124. However, it may be preferable that the second coil 121 and the third coil 122 do not contact each other. That is, the second coil 121 and the third coil 122 may be positioned eccentrically at both sides of the coil area of the first coil 111. Here, the coil area refers to the areas of a coil having a loop or a pseudo-loop structure, including the edge area of the coil forming the loop as well as the area inside the loop.

The sum total size of the second coil 121 and third coil 122 may be formed smaller than the size of the first coil 111. This is because the second coil 121 and the third coil 122 should be formed without extending beyond the area of the first coil 111 and without touching each other.

When formed on the second substrate 120, the second coil 121 and the third coil 122 can be formed with a particular gap in-between in predetermined thicknesses and predetermined sizes according to the particular number of turns. For example, the second coil 121 and third coil 122 can each have a size of 4.5 cm˜10 cm*10 cm˜20 cm as a three turn structure. Preferably, the second coil 121 and third coil 122 can be formed in a size of 4.5 cm*10 cm. Also, the second coil 121 and third coil 122 can be formed with a gap of about 1 cm in-between.

The second coil 121 and the third coil 122 can be formed in a smaller size than that of the first coil 111 but with a greater width (thickness). For example, the first coil 111 can be formed by winding a coil of a particular thickness for two turns along the edges of the first substrate 110 in a size of 10 cm*10 cm, while the second coil 121 and the third coil 122 can be formed by winding a coil of the same thickness as that of the first coil 111 for three turns along the edges of the 2A substrate 123 and the 2B substrate 124 in a size of 4.5 cm*10 cm. It may be preferable to design the second coil 121 and third coil 122 to have a relatively higher inductance than the first coil 111, so as to prevent inductance reduction at the second coil 121 and third coil 122, which have a relatively smaller size than the first coil 111.

The second coil 121 and the third coil 122 can be formed with the same vertical length but different horizontal length compared to the first coil 111. For example, the first coil 111 can be formed in a size of 10 cm*10 cm, and the second coil 121 and third coil 122 can each be formed in a size of 4.5 cm*10 cm. However, depending on which sides of the substrate the feed part 125, 126 are formed on, it is also possible to form the second coil 121 and the third coil 122 with the horizontal length made the same as that of the first coil 111 and with the vertical length made different from that of the first coil 111. Also, it is possible to form the second coil 121 and the third coil 122 to have a different horizontal length and a different vertical length compared to the first coil 111. However, considering that the second coil 121 and third coil 122 are to be formed on the second substrate 120 without extending beyond the area of the first coil 111, it may be preferable that the horizontal length and vertical length of the second coil 121 and third coil 122 be smaller than the horizontal length and vertical length of the first coil 111.

The second coil 121 and the third coil 122 can be formed on the second substrate 120 in rectangular shapes. However, the present disclosure is not to be limited by the shapes of the second coil 121 and third coil 122. For instance, the second coil 121 and third coil 122 can just as well be formed in another shape, including a polygon such as a rectangle, etc., a circle, an ellipse, and others.

While the second coil 121 and the third coil 122 can be formed in the same shape as that of the first coil 111, it is also possible for the second coil 121 and the third coil 122 to have shapes different from that of the first coil 111. The second coil 121 can also be formed in a shape different from that of the third coil 122.

While the second substrate 120 can have two coils 121, 122 formed thereon as illustrated in FIG. 3, the present disclosure is not limited thus. For instance, it is possible to have at least one more coil formed on the second substrate 120 between the second coil 121 and third coil 122 such that three or more coils are formed. In cases where at least one more coil is formed between the second coil 121 and third coil 122, it may be preferable that the coils be formed in a balanced manner between the second coil 121 and third coil 122.

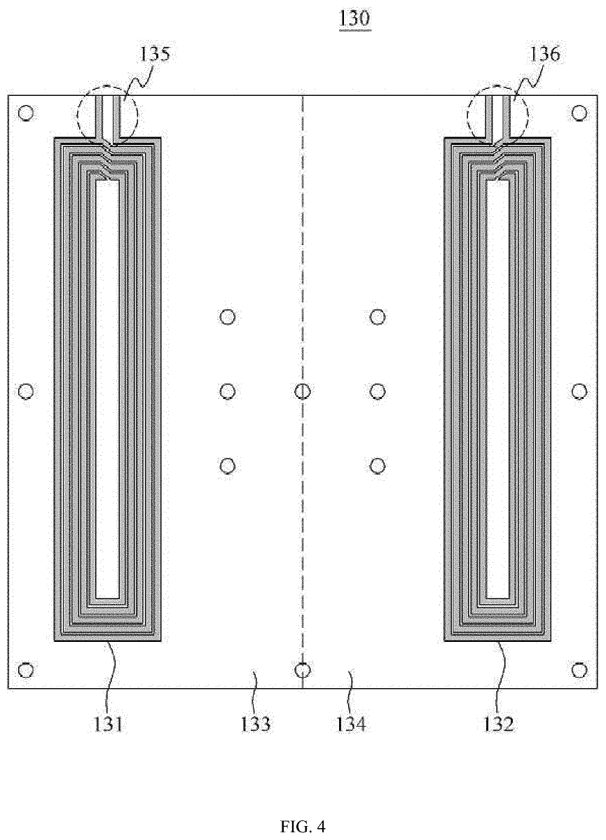

Next, with reference to FIG. 4, a description is provided of the third substrate 130 and a fourth coil 131 and a fifth coil 132 provided on the third substrate 130. FIG. 4 is a plan view of the third substrate included in a wireless power transmission apparatus.

The third substrate 130 may be positioned at the uppermost layer in the wireless power transmission apparatus 100 and may be formed over the second substrate 120. The third substrate 130 may include a fourth coil 131 and a fifth coil 132, which may be formed on a surface of the third substrate 130 in a symmetrical structure. While the third substrate 130 can be formed with the same size as that of the first substrate 110 and second substrate 120, it is also possible to form the third substrate 130 in a size different from that of at least one of the first substrate 110 and second substrate 120.

The fourth coil 131 and the fifth coil 132 may have smaller sizes compared to the first to third coils. The fourth coil 131 and the fifth coil 132 can be formed to have the same size at both sides on one surface of the third substrate 130. For example, the fourth coil 131 and the fifth coil 132 can be formed in the same size at the left side on the upper surface and at the right side on the upper surface of the third substrate 130, respectively. Of course, it is also possible to form the fourth coil 131 and the fifth coil 132 at different sides on different surfaces of the third substrate 130. For example, it is possible to have the fourth coil 131 formed biased to the left side on the upper surface of the third substrate 130 and have the fifth coil 132 formed biased to the right side on the lower surface of the third substrate 130. In this case, at least one of the second coil 121 and third coil 122 can be formed on the bottom surface of the second substrate 120 so as to prevent contact between the fifth coil 132 and the second coil 121 or third coil 122.

Referring to two equally bisected halves of the third substrate 130 as the 3A substrate 133 and the 3B substrate 134, the fourth coil 131 and the fifth coil 132 may be formed biased to the outer sides on the same plane of the 3A substrate 133 and the 3B substrate 134. For example, when the 3A substrate 133 is positioned at the left side and the 3B substrate 134 is positioned at the right side, the fourth coil 131 can be formed biased to the left end, and the fifth coil 132 can be formed biased to the right end. Of course, the fourth coil 131 and fifth coil 132 may also be formed so as not to be in contact with each other, similarly to the case of the second coil 121 and third coil 122. That is, the fourth coil 131 and fifth coil 132 may also be positioned eccentrically at both sides of the coil area of the first coil.

The sum total size of the fourth coil 131 and fifth coil 132 may be formed smaller than the sum total size of the second coil 121 and third coil 122.

The fourth coil 131 and the fifth coil 132 can be formed without touching each other within a range that does not extend beyond the area of the first coil 111, similarly to the case of the second coil 121 and third coil 122. Also, the fourth coil 131 and the fifth coil 132 can each be formed within a range that does not extend beyond the area of the second coil 121 and the third coil 122, respectively.

When formed on the third substrate 130, the fourth coil 131 and the fifth coil 132 can be formed with a particular gap in-between in predetermined thicknesses and predetermined sizes according to the particular number of turns. For example, the fourth coil 131 and fifth coil 132 can each have a size of 2.2 cm˜5 cm*10 cm˜20 cm as a five turn structure. Preferably, the fourth coil 131 and fifth coil 132 can be formed in a size of 2.2 cm*10 cm. Also, the fourth coil 131 and fifth coil 132 can be formed with a gap of about 5 cm in-between.

The fourth coil 131 and the fifth coil 132 can be formed in a smaller size but with a greater width (thickness) compared to the first coil 111, second coil 121, third coil 122, etc. For example, the first coil 111 can be formed by winding a coil of a particular thickness for two turns along the edges of the first substrate 110 in a size of 10 cm*10 cm, the second coil 121 and the third coil 122 can be formed by winding a coil of the same thickness as that of the first coil 111 for three turns along the edges of the 2A substrate 123 and the 2B substrate 124 in a size of 4.5 cm*10 cm, while the fourth coil 131 and the fifth coil 132 can be formed by winding a coil of the same thickness as that of the first coil 111, second coil 121, and third coil 122 for five turns along the edges of the 3A substrate 133 and the 3B substrate 134 in a size of 2.2 cm*10 cm. That is, it may be preferable to design the fourth coil 131 and fifth coil 132 to have a relatively higher inductance than the second coil 121 and third coil 122, so as to likewise prevent inductance reduction at the fourth coil 131 and fifth coil 132, which have relatively smaller sizes than the second coil 121 and third coil 122.

The fourth coil 131 and the fifth coil 132 can be formed with the same vertical length but different horizontal length compared to the first coil 111, second coil 121, and third coil 122. For example, the first coil 111 can be formed in a size of 10 cm*10 cm, and the second coil 121 and third coil 122 can each be formed in a size of 4.5 cm*10 cm, while the fourth coil 131 and fifth coil 132 can each be formed in a size of 2.2 cm*10 cm. However, depending on which sides of the substrate the feed part 135, 136 are formed on, it is also possible to form the fourth coil 131 and the fifth coil 132 with the same horizontal length and different vertical length compared to the first coil 111, second coil 121, and third coil 122. Also, it is possible to form the fourth coil 131 and the fifth coil 132 to have a different horizontal length and a different vertical length compared to the first coil 111, second coil 121, and third coil 122. However, considering that the fourth coil 131 and the fifth coil 132 are to be formed on the third substrate 130 without extending beyond the area of the first coil 111, it may be preferable that the horizontal length and vertical length of the fourth coil 131 and fifth coil 132 be smaller than the horizontal lengths and vertical lengths of the first coil 111, second coil 121, and third coil 122.

The fourth coil 131 and the fifth coil 132 can be formed on the third substrate 130 in rectangular shapes, as illustrated in FIG. 4. However, the present disclosure is not to be limited by the shapes of the fourth coil 131 and fifth coil 132. For instance, the fourth coil 131 and fifth coil 132 can just as well be formed in another shape, including a polygon such as a rectangle, etc., a circle, an ellipse, and others.

While the fourth coil 131 and the fifth coil 132 can be formed in the same shape as the first coil 111, second coil 121, third coil 122, etc., it is also possible for the fourth coil 131 and the fifth coil 132 to have shapes different from those of the first coil 111, second coil 121, third coil 122, etc. The fourth coil 131 can also be formed in a shape different from that of the fifth coil 132, but in order that the same performance may be obtained at both sides of the third substrate 130, it may be preferable to have the fourth coil 131 be formed in the same shape as that of the fifth coil 132.

While the third substrate 130 can have two coils 131, 132 formed thereon as illustrated in FIG. 4, the present disclosure is not limited thus. For instance, it is possible to have at least one more coil formed on the third substrate 130 between the fourth coil 131 and the fifth coil 132 such that three or more coils are formed. In cases where at least one more coil is formed between the fourth coil 131 and fifth coil 132, it may be preferable that the coils be formed in a balanced manner between the fourth coil 131 and fifth coil 132.

Although it is not illustrated in FIG. 1, it is possible for the wireless power transmission apparatus 100 to include at least one or more substrate over the third substrate 130.

Regarding the substrates stacked over the third substrate 130, the substrates that are positioned at increasingly higher levels can have two coils formed symmetrically at both ends with increasingly greater eccentricities. Here, the coils can be formed to have relatively smaller sizes but conversely with greater widths (thicknesses). However, the present disclosure is not limited thus.

Moreover, it is possible to change the positions of the substrates on which the coils of different sizes are formed. For example, it would also be possible to arrange the first substrate above the second substrate and arrange the third substrate above the first substrate.

To each of the coils formed on the substrates, a signal for wireless charging may be fed independently. That is, a signal for wireless charging may be fed independently to each of the first coil, second coil, third coil, fourth coil, and fifth coil mentioned in the embodiment described with reference to FIG. 1 through FIG. 4.

A charging signal may be provided to the coils formed on the first substrate, second substrate, and third substrate in an embodiment of the disclosure via selective feeding by way of switching according to the position of the charging target apparatus. For example, if the charging target apparatus is at a particular position, a feed signal may be provided only to the first coil of the first substrate to enable wireless charging by way of the first coil. For the second coil, third coil, fourth coil, and fifth coil, the connections to the feed part may be disengaged by a switch, and the feed signal may not be provided these coils.

Also, if the charging target apparatus is at another position, the feed signal may be provided only the second coil and third coil of the second substrate, and the feed signal may not be provided to the first coil, fourth coil, and fifth coil, so that only the second coil and third coil of the second substrate may receive the feed signal.

The matter of providing the feed signal to a coil of which one of the substrates may be determined according to the position of the charging target apparatus.

A reason for positioning the coils of the second substrate and third substrate eccentrically at both sides with respect to the coil area of the base coil (first coil) in an embodiment of the disclosure is so that, when the charging target apparatus is positioned outside the coil area of the base coil (first coil), the coils may be positioned as closely as possible to the misaligned charging target apparatus.

A reason for making the sizes different for the second coil and third coil on the second substrate and the fourth coil and fifth coil on the third substrate is to vary the intensity of the magnetic field provided by each coil according to position.

For example, when the charging target apparatus is at a particular position in a misaligned state, it may not be able to receive a proper magnetic field from the second coil and third coil but may be able to receive a proper magnetic field from the fourth coil and fifth coil, and therefore in this case, wireless charging may be performed by providing the feed signal to the fourth coil and fifth coil.

The features of a wireless power transmission apparatus 100 proposed by an embodiment of the disclosure may be summarized as follows.

First, a stacked structure is provided, in which coils of different sizes and coil properties (turn number, line thickness, etc.) are stacked together.

Second, the overall size may be limited to the size of the base coil, i.e. the first coil 111 of FIG. 2.

Third, the overall efficiency may be improved by way of switching between the operating coils according to the position of the charging target apparatus.

Fourth, the coils of the substrates stacked over the first substrate may be arranged eccentrically at both sides of the coil area of the base coil, so as to improve misalignment.

Fifth, the coils arranged on the respective layers can have different sizes and properties. The coils arranged on the layers can be designed to have different sizes but with increasingly higher inductance values for increasingly smaller sizes.

Sixth, the shapes of the coils arranged on each layer are not limited to that of the main coil. That is, the coils arranged on each layer can have various shapes. Also, the shapes arranged on each layer can involve the coils being contracted according to the misalignment position anticipated during wireless power transmission.

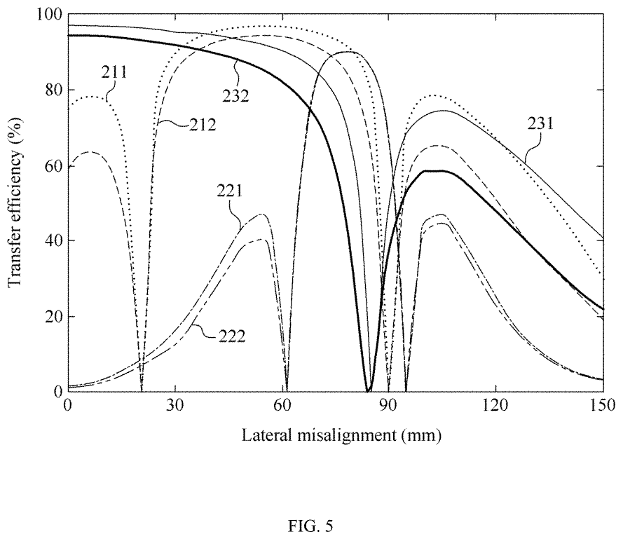

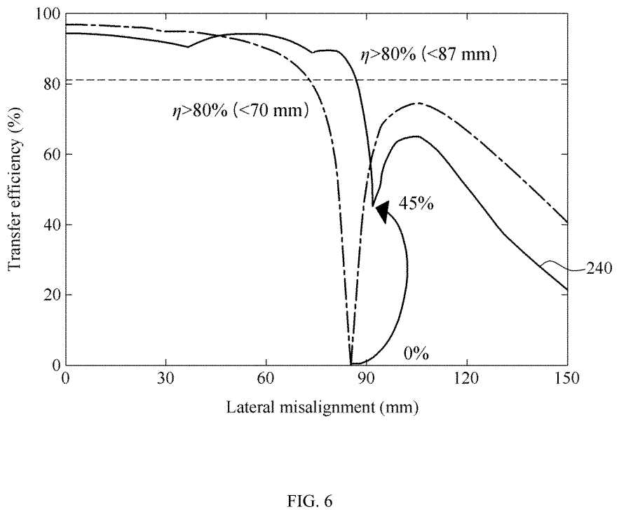

FIG. 5 and FIG. 6 are graphs representing the transfer efficiency obtained with an embodiment of the disclosure. In FIG. 5 and FIG. 6, the numeral 211 represents simulation results for a wireless power transmission apparatus that includes only the first substrate 110, and the numeral 212 represents test measurement results for a wireless power transmission apparatus that includes only the first substrate 110. The numeral 221 represents simulation results for a wireless power transmission apparatus that includes only the second substrate 120, and the numeral 222 represents test measurement results for a wireless power transmission apparatus that includes only the second substrate 120. Also, the numeral 231 represents simulation results for a wireless power transmission apparatus that includes only the third substrate 130, and the numeral 232 represents test measurement results for a wireless power transmission apparatus that includes only the third substrate 130. Lastly, the numeral 240 represents test measurement results for a wireless power transmission apparatus that includes all of the first substrate 110, second substrate 120, and third substrate 130.

Referring to FIG. 5, in cases where only one of the first substrate 110 to third substrate 130 is used, there is the problem that the efficiency of wirelessly transmitting power can become very subpar depending on the skewed angle when the wireless power transmission apparatus and the target being charged are in a misaligned state.

Referring to FIG. 6, however, in cases where the first substrate 110 to third substrate 130 are all used, a much higher wireless power transfer efficiency can be obtained, compared to the existing setups, regardless of the skewed angle between the wireless power transmission apparatus and the target being charged. This is because the charging may be performed with the feeding provided to the coil of the substrate that is the most suitable for the current misalignment state from among the first substrate 110 to third substrate 130.

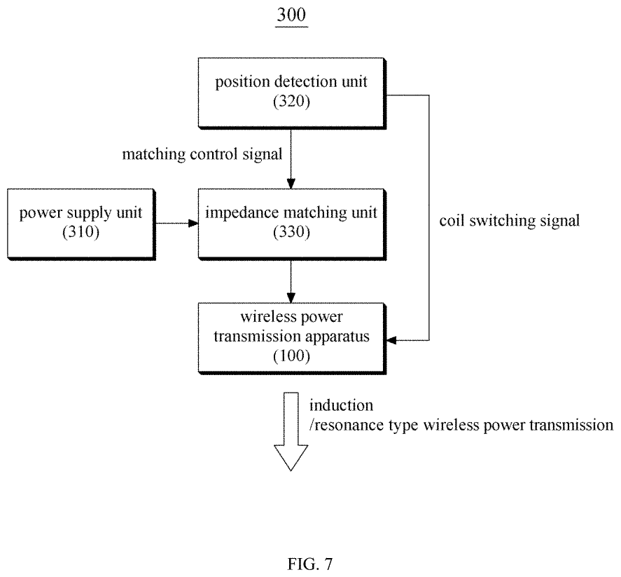

FIG. 7 is a conceptual diagram illustrating a wireless power transmission system equipped with a wireless power transmission apparatus.

As shown in FIG. 7, a wireless power transmission system 300 may include a power supply unit 310, a position detection unit 320, an impedance matching unit 330, and a wireless power transmission apparatus 100.

The power supply unit 310 may serve to supply the power that is to be transmitted to the target of which charging is desired. The method of energy transmission, such as those using magnetic induction, magnetic resonance, etc., can be determined by the power supply unit 310 that is positioned at the transmitter end.

The position detection unit 320 may serve to detect the position of the charging target apparatus. When the position of the target that is to be charged is detected, the position detection unit 320 may output a matching control signal to the impedance matching unit 330 and may output a coil switching signal to the wireless power transmission apparatus 100. That is, the coil to which the feed signal is provided may be determined according to the detected position. Various known methods can be used for the position detection.

The impedance matching unit 330 may serve to perform impedance matching between the target that is to be charged and the wireless power transmission system 300, to allow interconnection between the target that is to be charged and the wireless power transmission system 300.

The wireless power transmission apparatus 100 can be implemented in the form of stacked coils. As the wireless power transmission apparatus 100 has been described above with reference to FIG. 1 through FIG. 6, redundant explanations are omitted here. While the wireless power transmission apparatus 100 can be applied to either one of the wireless power transmission system 300, which corresponds to the transmitter end, and the target that is to be charged, which corresponds to the receiver end, it is also possible to apply the wireless power transmission apparatus 100 to both of the above. In cases where the wireless power transmission apparatus 100 is applied to the target being charged, the first substrate 110 to third substrate 130 can be stacked in reverse order in an embodiment of the disclosure.

It is also possible for the wireless power transmission system 300 to determine which coils to provide the feed signal to, by way of a test process, without detecting the position of the charging target apparatus. For example, it would be possible to provide a test feed signal sequentially to the first coil of the first substrate, the second coil and third coil of the second substrate, and the fourth coil and fifth coil of the third substrate, and then based on feedback from the charging target apparatus, provide the feeding to the coils that yield the highest power efficiency.

Also, instead of using feedback from the charging target apparatus, the wireless power transmission system 300 can use the intensities of reflection signals returned from the test feed signals and provide feeding to the coils that yield the highest power efficiency.

The descriptions above provided with reference to FIG. 1 through FIG. 7 illustrate an embodiment of the disclosure. The descriptions that follow illustrate preferred embodiments of the disclosure that can be derived from the embodiment of the disclosure described above.

A wireless power transmission apparatus according to a preferred embodiment of the disclosure may be an apparatus for transmitting power wirelessly to a target for which a supply of power is desired and may include a first coil layer, a second coil layer, and a third coil layer. The wireless power transmission apparatus may be a concept corresponding to the wireless power transmission apparatus 100 shown in FIG. 1.

The first coil layer may include a coil. The first coil layer may be a concept corresponding to the first substrate 110 of FIG. 1 and FIG. 2, and the coil included in the first coil layer may be a concept corresponding to the first coil 111 of FIG. 2.

The second coil layer may be formed over the first coil layer and may include coils formed at both sides, respectively. The second coil layer may be a concept corresponding to the second substrate 120 of FIG. 1 and FIG. 3, while the coils included in the second coil layer may be concepts corresponding to the second coil 121 and third coil 122 of FIG. 3.

The coils included in the second coil layer can be formed within an area corresponding to the area formed by the coil included in the first coil layer.

The coils included in the second coil layer can be formed not to be in contact with each other.

The coils included in the second coil layer can have a smaller size and a thicker width compared to the coil included in the first coil layer. The coils included in the second coil layer, as well as the coils included in the third coil layer, can be adjusted in width by arranging materials of the same thickness in tight contact in one direction.

The second coil layer can further include at least one coil positioned in a balanced manner between the coils included in the second coil layer.

The third coil layer may be formed over the second coil layer and may include coils that are formed in positions corresponding to the coils included in the second coil layer but are formed more eccentrically towards the perimeter compared to the coils included in the second coil layer. The third coil layer may be a concept corresponding to the third substrate 130 of FIG. 1 and FIG. 4, and the coils included in the third coil layer may be concepts corresponding to the fourth coil 131 and fifth coil 132 shown in FIG. 4.

The coils included in the third coil layer can have smaller sizes but thicker widths compared to the coil included in the first coil layer. Also, the coils included in the third coil layer can have smaller sizes but thicker widths compared to the coils included in the second coil layer.

The coils included in the third coil layer can be adjusted in width by arranging materials of the same thickness in tight contact in one direction.

The coils included in the third coil layer can be formed within an area corresponding to the area formed by the coil included in the first coil layer. Also, the coils included in the third coil layer can be formed within areas corresponding to the areas formed by the coils included in the second coil layer.

The coils included in the third coil layer can be formed in quadrilateral shapes. Here, one of the horizontal and vertical length can be the same as that of the coils included in the second coil layer, and the other can be formed shorter than that of the coils included in the second coil layer.

The coils included in the third coil layer can be formed symmetrically to each other.

The coils included in the third coil layer can be formed not to be in contact with each other. The coils included in the third coil layer can be formed not to be in contact with the coils included in the second coil layer, either.

The third coil layer can further include at least one coil positioned in a balanced manner between the coils included in the third coil layer.

The first coil layer, the second coil layer, and the third coil layer can each be formed by winding coils on the same surface of a respective substrate.

A wireless power reception apparatus according to a preferred embodiment of the disclosure may be an apparatus for receiving power wirelessly from a counterpart providing power and may include a first coil layer, a second coil layer that is formed below the first coil layer and includes coils formed at both sides, and a third coil layer that is formed below the second coil layer and includes coils formed in positions corresponding to the coils included in the second coil layer with the coils formed more eccentrically towards the perimeter than the coils included in the second coil layer.

The difference between the wireless power reception apparatus and the wireless power transmission apparatus is that, whereas the wireless power transmission apparatus has the coil layers stacked in the order of the first coil layer, the second coil layer, and then the third coil layer, the wireless power reception apparatus has the coil layers stacked in the order of the third coil layer, the second coil layer, and then the first coil layer.

Next, a description is provided of a wireless power transmission system equipped with a wireless power transmission apparatus.

The wireless power transmission system may include a power supply unit, an impedance matching unit, and a wireless power transmission apparatus. The wireless power transmission system may be a concept corresponding to the wireless power transmission system 300 shown in FIG. 7.

The power supply unit may serve to supply power to the target for which power supply is desired. The power supply unit may be a concept corresponding to the power supply unit 310 of FIG. 7.

The impedance matching unit may serve to perform impedance matching with the target that is to receive the power supply. The impedance matching unit may be a concept corresponding to the impedance matching unit 330 of FIG. 7.

The wireless power transmission system can further include a position detection unit. The position detection unit may serve to detect the position of the target receiving power and perform control functions for the impedance matching unit and the wireless power transmission apparatus. The position detection unit may be a concept corresponding to the position detection unit 320 of FIG. 7.

Even if the descriptions above refer to certain components of an embodiment of the disclosure being coupled as one or operating in a coupled manner, the present disclosure is not necessarily limited to such embodiment. That is, within the scope encompassed by the purpose of the disclosure, the components can operate in one or more selectively coupled combinations. Also, while the components can each be implemented as an independent piece of hardware, it is also possible to have some or all of the components selectively combined to be implemented as a computer program having program modules for performing some or all combined functions in one or more pieces of hardware.

Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present specification.

The descriptions above merely provide examples for illustrating the technical spirit of the present disclosure, and a person having ordinary skill in the field of art to which the present disclosure pertains would be able to achieve various modifications, alterations, and substitutions without departing from the essence of the disclosure. Thus, the embodiments described for the disclosure and the appended drawings are intended not to limit but rather to illustrate the spirit of the disclosure, and the technical spirit of the disclosure is not limited by such embodiments and appended drawings. The scope of protection of the present disclosure is to be interpreted from the scope of claims set forth below, and all technical concepts within the claims and their equivalents are to be interpreted as being encompassed within the scope of rights of the disclosure.

What is claimed is:

1. An apparatus for transmitting power wirelessly to a charging target apparatus being supplied power, the apparatus comprising:
a first coil layer comprising a coil; and
a second coil layer separated longitudinally from the first coil layer, the second coil layer comprising coils formed eccentrically at both sides of a coil area of the first coil layer,
wherein the coils of the second coil layer have smaller sizes than the coil of the first coil layer.

2. The apparatus for transmitting power wirelessly according to claim 1, further comprising a third coil layer separated longitudinally from the second coil layer, the third coil layer comprising coils formed eccentrically at both sides of the coil area of the first coil layer, the coils of the third coil layer having different sizes from the coils of the second coil layer.

3. The apparatus for transmitting power wirelessly according to claim 2, wherein the coils formed on the second coil layer and the coils formed on the third coil layer have symmetrical structures.

4. The apparatus for transmitting power wirelessly according to claim 1, wherein the first coil layer, the second coil layer, and the third coil layer are formed on different substrates.

5. The apparatus for transmitting power wirelessly according to claim 2, wherein a feed signal for wireless charging is provided to at least one coil layer selected by switching from among the first coil layer, the second coil layer, and the third coil layer.

6. The apparatus for transmitting power wirelessly according to claim 5, further comprising a position detection unit configured to detect a position of the charging target apparatus, wherein the coil layer for providing the feed signal by the switching is selected based on a position detected by the position detection unit.

7. The apparatus for transmitting power wirelessly according to claim 5, wherein at least one particular coil layer is selected by the switching after providing a test feed signal to the first coil layer, the second coil layer, and the third coil layer sequentially, the at least one particular coil layer selected such that feeding is performed to a coil layer having a highest charging efficiency.

8. An apparatus for receiving power wirelessly from a counterpart providing power, the apparatus comprising:
a first coil layer comprising a coil; and
a second coil layer separated longitudinally from the first coil layer, the second coil layer comprising coils formed eccentrically at both sides of a coil area of the first coil layer,
wherein the coils of the second coil layer have smaller sizes compared to the coil of the first coil layer.

9. An apparatus for transmitting power wirelessly, the apparatus comprising:
a plurality of substrates stacked sequentially; and
a plurality of coil layers formed respectively on the plurality of substrates,
wherein one of the coil layers is composed of a single coil, coil layers other than the coil layer composed of a single coil include coils formed eccentrically at both sides of a coil area of the single coil, and the coils of the plurality of coil layers have different sizes.

10. The apparatus for transmitting power wirelessly according to claim 9, wherein coils in a particular coil layer formed eccentrically at both sides of the coil area of the single coil have a symmetrical structure.

11. The apparatus for transmitting power wirelessly according to claim 9, wherein a feed signal for wireless charging is provided to at least one coil layer selected by switching from among the plurality of coil layers.

12. The apparatus for transmitting power wirelessly according to claim 11, further comprising a position detection unit configured to detect a position of a charging target apparatus, wherein the coil layer for providing the feed signal by the switching is selected based on a position detected by the position detection unit.

13. The apparatus for transmitting power wirelessly according to claim 11, wherein at least one particular coil layer is selected by the switching after providing a test feed signal to the plurality of coil layers sequentially, the at least one particular coil layer selected such that feeding is performed to a coil layer having a highest charging efficiency.
